(19) United States
(12) Patent Application Publication
(10) Pub. No.: US 2021/0195726 A1
(43) Pub. Date: Jun. 24, 2021

(54) LINEAR ACCELERATOR USING A STACKED ARRAY OF CYCLOTRONS

(71) Applicant: James Andrew Leskosek, Summerland (CA)

(72) Inventor: James Andrew Leskosek, Summerland (CA)

(21) Appl. No.: 17/117,447

(22) Filed: Dec. 10, 2020

Related U.S. Application Data
(60) Provisional application No. 62/947,259, filed on Dec. 12, 2019.

(51) Int. Cl. H05H 13/10; H05H 13/00; H05H 9/00; H05H 7/04

(52) U.S. Cl. CPC H05H 13/10; H05H 13/005; H05H 2007/045; H05H 7/04; H05H 9/00

(57) ABSTRACT

A linear accelerator comprises a plurality of cyclotrons arranged axially in a cyclotron stack, each cyclotron having a set of dees and a central aperture passing through the set of dees. Each central aperture is axially aligned with one another in the stack, forming a central channel having an inlet and an outlet that passes through the stack. Magnets are positioned so as to generate a magnetic field perpendicular to the set of dees. A power supply applies an oscillating voltage to each set of dees of the stack. In operation, subatomic particles are ejected radially outwardly of the stack, creating a dead zone within the central channel that is void of particles and electromagnetic fields. A mass or light beam is accelerated as it passes through the central channel's dead zone, due to the absence of frictional forces acting on the mass or light within the dead zone.

### CROSS-REFERENCE TO RELATED APPLICATION

This application claims priority to U.S. Provisional Patent Application No. 62/947,259 filed on Dec. 12, 2019, the entirety of which is incorporated herein by reference.

### FIELD

The present disclosure relates to linear particle accelerators and cyclotrons.

### BACKGROUND

There are four known fundamental forces which control matter and energy; namely: strong nuclear forces, weak nuclear forces, electromagnetic force, and gravitational force. In the 1970s, physicists realized that there are very close ties between two of the four fundamental forces: the weak nuclear force and the electromagnetic force. The two forces can be described within the same theory, which forms the basis of the Standard Model. This “unification” implies that electricity, magnetism, light and some types of radioactivity are all manifestations of a single underlying force, known as the electroweak force.

The basic equations of the unified theory correctly describe the electroweak force and its associated force-carrying particles, namely the photon, and the W and Z bosons, except for one issue: all of these particles emerge from the equations without a mass. While this is true for the photon, we know that the W and Z bosons have mass, nearly 100 times that of a proton. The answer to this issue is the Brout-Englert-Higgs mechanism, proposed by the theorists Robert Brout, Francois Englert and Peter Higgs. This mechanism gives a mass to the W and Z bosons when they interact with an invisible field, called the “Higgs field”, which pervades the universe. Immediately after the big bang, the Higgs field was zero, but as the universe cooled and the temperature fell below a critical value, the field grew spontaneously so that any particle interacting with it acquired a mass. The more a particle interacts with the Higgs field, the heavier it becomes. Particles like the photon that do not interact with the Higgs field are left with no mass at all. Like all fundamental fields, the Higgs field has an associated particle, called the Higgs boson. For years, scientists unsuccessfully attempted experiments to observe the Higgs boson in order to confirm the Brout-Englert-Higgs mechanism. Then a breakthrough occurred on Jul. 4, 2012, when the ATLAS and Compact Muon Solenoid (“CMS”) experiments at CERN's Large Hadron Collider (“LHC”) announced they had each observed a new particle in the mass region of approximately 125 GeV. While the observations of the new particle are consistent with the Higgs boson, it will take further work to determine whether or not it is the Higgs boson predicted by the Standard Model. The Higgs boson, as proposed within the Standard Model, is the simplest manifestation of the Brout-Englert-Higgs mechanism.

The CMS and ATLAS detectors are used to investigate a wide range of physics, from the search for the Higgs boson to extra dimensions and particles that could make up dark matter. On Oct. 8, 2013 the Nobel Prize in physics was awarded jointly to Franoois Englert and Peter Higgs for the theoretical discovery of a mechanism that contributes to our understanding of the origin of mass of subatomic particles, and which recently was confirmed through the discovery of the predicted fundamental particle, by the ATLAS and CMS experiments at CERN's LHC. (The above excerpts were obtained from an article entitled “The Higgs Boson”, published on the European Organization for Nuclear Research (CERN) website at https://home.cern/science/physics/higgs-boson; last accessed on Feb. 12, 2020).

NASA's Gravity Probe B (“GP-B”) mission has confirmed two key predictions derived from Albert Einstein's general theory of relativity, which the GP-B spacecraft was designed to test. The experiment, launched in 2004 and decommissioned in 2010, used four ultra-precise gyroscopes to measure the hypothesized geodetic effect (the warping of space and time around a gravitational body), and frame-dragging (the amount a spinning object pulls space and time with it as it rotates). The GP-B determined both effects with unprecedented precision by pointing at a single star, IM Pegasi, while in a polar orbit around Earth. If gravity did not affect space and time, GP-B's gyroscopes would point in the same direction forever while in orbit. However, in confirmation of Einstein's theories, the gyroscopes experienced measurable, minute changes in the direction of their spin, while Earth's gravity pulled at them. (The above excerpts obtained from a NASA news release no. 11-134, dated May 3, 2011 and published on NASA's website at https://www.nasa.gov/home/hqnews/2011/may/HQ_11-134_Gravity_Probe_B.html; last accessed on Feb. 12, 2020).

It has been observed by Albert Einstein that time travels slower the faster an observer travels. This is referred to as time dilation, or gravitational time dilation. This phenomenon is also seen in black holes where time moves slower in the accretion disk.

Friction is the force that resists the relative motion of material elements sliding against one another. The mechanisms responsible for the force of friction occur at the molecular level. One contributing mechanism to the force of friction, according to research conducted by Gary McClelland and Jeffrey Sokoloff in the 1980s, are sound waves referred to as phonons. When an object rubs against another object, it has been demonstrated that the surface atoms of the object are “plucked” like the strings of a guitar. As one layer of atoms moves across another layer of atoms, the atoms start bobbing back and forth as vibrations, or phonons, travel along the surface. The energy of motion of one layer is turned into waves, and the more energy that is lost, the harder it becomes to move the two surfaces over each other. Another mechanism contributing to the force of friction is electrons. The electron clouds that surround the nucleus of each atom fluctuate randomly. For example, a denser, more negative portion of the electron cloud will repel the electron cloud on an adjacent atom, thereby inducing a positive charge. The induced, positive charge of the adjacent atom is then attracted to the more negative portion of the first atom; such forces are known as Van der Waals forces. The physicist, Mats Persson, has suggested that over a short range, the free electrons in the surface of a metal might be attracted by van der Waals forces from an adjacent surface. Moving the adjacent surface would therefore drag along with it the electrons in the metal, creating a weak current in the surface. As with most electrical currents, there will be a resistance as the moving electrons are impeded by the atoms or surface imperfections that they encounter. Thus the electrons act like anchors, causing drag. (The above excerpts adapted from C. Seife and B. Crystall, “There's the Rub”, New Scientist, Vol. 160 No. 2156, p. 30).

Invented by Ernest O. Lawrence in the 1930s, the cyclotron is a type of particle accelerator which accelerates charged particles outwardly from the center of a flat cylindrical vacuum chamber along a spiral path. The charged particles are maintained in a spiral trajectory by a magnetic field, and accelerated by a varying electric field.

### SUMMARY

Since the electron contributes to the force of friction, the applicant theorizes the electron, and the electromagnetic field, may also be the sole contributors to time. If this theory is correct, this would also explain the quantum effect. A quantum effect is any phenomenon which cannot be fully explained by classical mechanics. An example of a quantum effect includes the phenomenon that an atom, or a subatomic particle such as an electron, is demonstrably capable of being in two locations at the same time. Another example of a quantum effect, at the elementary particle level, includes experiments such as the delayed quantum eraser and the delayed-choice quantum eraser, which may demonstrate that the past can be re-written. For example, see the work on the delayed-choice quantum eraser experiment by Yoon-Ho Kim et al.: Kim, Yoon-Ho; R. Yu; S. P. Kulik; Y. H. Shih; Marlan Scully (2000). “A Delayed “Choice” Quantum Eraser.” Physical Review Letters. 84 (1): 1-5, Jan. 3, 2000.

Following these principles, the applicant postulates the following:
1. It may be possible to use cyclotrons to push out electrons from a given area, thus creating a dead zone in the electromagnetic field that exists in space.
2. If one lines up cyclotrons so as to create a dead zone cavity in the electromagnetic field in the center of a stack of cyclotrons, it may be possible to make an accelerator or gun.

Inside the tube-like dead zone channel running through the center of the stack of cyclotrons, and existing without the electromagnetic field, the space defined by the dead zone is frictionless, which means the laws of physics that are governed in the electromagnetic field do not affect a projectile or vehicle that passes through the dead zone. If the electron activity is increased in a tube, the object passing through slows down, but when it leaves the tube it is able to retain that velocity. The applicant proposes that in a dead zone, from which the electromagnetic field is absent, the object will maintain its momentum upon leaving the cyclotron stack.

In one aspect of the present disclosure, a linear accelerator comprises a plurality of cyclotrons arranged axially in a cyclotron stack, each cyclotron of the plurality of cyclotrons comprising a set of dees and a central aperture passing through the set of dees. Each central aperture of each cyclotron is axially aligned with one another in the stack, forming a central channel that passes through the cyclotron stack, the central channel having an inlet and an outlet. At least two magnets are provided, where the first magnet is positioned adjacent the inlet and a second magnet is positioned adjacent the outlet. However, it will be appreciated that the stack may include a plurality of magnets, interleaved between each set of dees in the cyclotron stack, in addition to the first and second magnets located adjacent the inlet and outlet of the central channel. Furthermore, the magnets may be any type of magnet suitable for producing the required magnetic field perpendicular to each set of dees, and may include for example electromagnets. A power supply is configured to apply an oscillating voltage to each set of dees of the cyclotron stack. When in operation, subatomic particles are ejected radially outwardly of the plurality of cyclotrons in the stack, thereby creating a dead zone within the central channel of the stack. The dead zone is void of particles, subatomic particles and electromagnetic fields. A mass entering the inlet of the central channel of the cyclotron stack is accelerated as it passes through the dead zone of the central channel and the outlet, as a result of the absence of frictional forces acting on the mass within the dead zone of the central channel.

In embodiments that include electromagnets, the power supply may be configured to also power the electromagnets, or else the electromagnets may have a separate power supply. In some embodiments, the power supply may be a controlled pulsed power supply configured to apply a pulsed power voltage to each set of dees of the plurality of cyclotrons.

The mass may be any mass that requires acceleration. For example, the mass may be a projectile. The mass may also be a vehicle for space travel. In some embodiments, the linear accelerator could be configured as a propulsion system for propelling a vehicle through an atmosphere, wherein the mass accelerated by the linear accelerator includes the atmosphere surrounding the vehicle. Subatomic particles, as described herein, may include electrons and virtual particles.

In other embodiments, instead of accelerating a mass through the linear accelerator, a beam of light may be passed through the linear accelerator, wherein the beam of light gains energy as it passes through the central channel of the linear accelerator and the outlet. The beam of light may be configured as a laser, whereby the laser gains energy as it passes through the central channel and outlet of the linear accelerator.

### BRIEF DESCRIPTION OF THE DRAWINGS

FIG. 1 is a perspective view of a linear accelerator, in accordance with an embodiment of the present disclosure.

FIG. 2 is a cut-away perspective view of a cyclotron stack of the linear accelerator illustrated in FIG. 1, with lines representing ejected electrons or virtual particles removed for clarity.

FIG. 3 is the cut-away perspective view of a cyclotron stack of FIG. 2, additionally illustrating lines representing the ejected electrons or virtual particles that are proximate the cyclotron illustrated therein.

FIG. 4 is an illustration of lines representing ejected electrons or virtual particles proximate the linear accelerator shown in FIG. 1, and lines representing a light wave entering and exiting the linear accelerator, with the linear accelerator removed for clarity.

### DETAILED DESCRIPTION

The principles and operations of a cyclotron, which is a type of particle accelerator, are well known in the art. Invented in the 1930s, early designs of the cyclotron comprised a flattened, cylindrical vacuum chamber installed between the two poles of a large electromagnet. When current is supplied to the two poles of the electromagnet, a magnetic field is created perpendicular to the direction of travel of the particle beam within the vacuum chamber. The flat vacuum chamber consists of two hollow, D-shaped electrodes, referred to as “dees”, which are separated from each other by a gap. When an oscillating voltage is applied to the two dees, which are insulated from each other across the gap, the oscillating voltage creates an oscillating electric field in the gap between the dees which accelerates the particles each time the particles pass through the gap while moving through their spiral-shaped path of travel within the flattened cylindrical vacuum chamber.

The frequency of voltage oscillation is set so that the particles make one circuit during a single voltage cycle. In order to achieve this, the frequency must match the particles' cyclotron resonance frequency. In this manner, each time the particles cross the gap from one electrode to the other electrode (the dees), the polarity of the applied voltage reverses, and so the electric field in the gap is in the correct direction to accelerate the particles passing through the gap. The increasing speed of the particles, due to the acceleration across the gap that occurs, causes the particles to move in a spiral path outwardly from the center of the chamber to the rim of the dees. In a cyclotron, the particles encounter the accelerating voltage many times during their spiral path, and so they are accelerated many times such that the output energy of the particle beam may be many times the accelerating voltage.

Advancements in the design of cyclotrons include the design of dees having different geometries, such as the spiral dees, which may include three or more dee electrodes within the set of dees of a cyclotron. However, the general principle remains the same, in that each dee within a set of dees are each insulated from one another by a gap, and applying an oscillating voltage to the set of dees creates an oscillating electric field across the gaps between the dees, thereby accelerating the particles each time the particles cross a gap between dees.

Other developments in the field of cyclical particle accelerators include the synchrocyclotron, which is a type of cyclotron that was patented by Edwin McMillan. A synchrocyclotron differs from a cyclotron in that the frequency of the radiofrequency (“RF”) electric field is varied to compensate for the relativistic effects of the particles' velocity as the particles begin to approach the speed of light. One terminal of the power supply's oscillating electric potential, varying periodically, is applied to the dee and the other terminal is at ground potential. Thus, the resulting electric field generated by the oscillating electric potential has a variable frequency, which contrasts with the classical cyclotron design, in which the frequency of the generated electric field is constant.

Other developments in the field of cyclical particle accelerators include the synchrotron, which was invented by Vladimir Veksler in 1944. In a synchrotron, acceleration of the particles is done by variation of the magnetic field strength in time, rather than in space. For particles that are not close to the speed of light, the frequency of the applied electromagnetic field may also be varied so as to follow the non-constant circulation time of the particles. These principles allow particles to gain energy as they are accelerated.

Although some designs of the cyclotron utilized an oscillating voltage source to generate the oscillating electric field between the dees, it will be appreciated by a person skilled in the art that other methods of generating an oscillating electric field may be used, such as using a controlled pulse power supply.

As the term “cyclotron” is used herein, the applicant intends for this term to include not only cyclotrons, but also synchrotrons, synchrocyclotrons, and other configurations or variations of particle accelerators that accelerate particles as the particles travel in a circular or spiral path. As will be appreciated by a person skilled in the art, different configurations of particle accelerators that accelerate particles in a circular or spiral path, and which thereby have the effect of removing particles from a space in the center of the particle accelerator, may be used in the novel linear accelerator that is described herein.

The applicant observes that the operation of the cyclotron has the effect of accelerating particles away from the center of the vacuum chamber of the cyclotron, and towards the outer edges of that vacuum chamber. Thus, in the absence of a source of new particles being introduced to the center of the cyclotron's vacuum chamber, the operation of the cyclotron effectively removes any particles from the center of the cyclotron and evacuates the electrons from the cyclotron. Such particles may include, for example, the molecules, atoms and subatomic particles that make up an atmosphere surrounding the cyclotron apparatus. As another example, if the cyclotron is located beyond a planetary atmosphere in outer space, even outer space is not truly “empty” and includes the existence of molecules, atoms and subatomic particles within the central aperture of the cyclotron, or the central channel of a stack of cyclotrons, that would be accelerated and thus, removed from the center of the cyclotron (or stack of cyclotrons) during operation. This causes formation of a dead zone within the central channel of the cyclotron stack, such that no particles exist within the dead zone. The applicant postulates the dead zone may be void of any particles or fields, or that the dead zone may consist of a negative field.

Furthermore, the applicant hypothesizes that the removal of any particles from the center of the cyclotron, such as electrons, also effectively removes any field, such as an electromagnetic field or a Higgs field, from the center of the cyclotron. According to quantum mechanics, a vacuum is not completely “empty”. Rather, a vacuum, from which atoms and subatomic particles have been evacuated, still contains quantum energy and particles that momentarily blink into and out of existence; in other words, detected signals that are known as quantum fluctuations. In physics, a virtual particle is a transient quantum fluctuation that exhibits some of the characteristics of an ordinary particle, while having its existence limited by the uncertainty principle.

By removing all particles and fields from the center of the cyclotron, including electromagnetic fields and the Higgs field, the applicant theorizes that a dead zone is created within the center of the cyclotron, where no fields and no particles exist. In the dead zone, because there are no particles and no electromagnetic field or any other type of field (other than, perhaps, a negative field), there is nothing to produce the force of friction in order to slow down particles that may be travelling through the dead zone. The applicant theorizes that, with the absence of the Higgs field, the relativistic mass formula does not apply. As a result, in the dead zone: 1) there is no increase in mass; 2) there is no contraction in the direction of travel (referred to as the Lorentz Transformation); and 3) there is no “slowing down” of time (referred to as lime Dilation). The applicant hypothesizes that this may mean the accelerating mass (ie: the relativistic mass) would never approach infinite mass in special relativity. Assuming that any particles which enter the dead zone have a momentum at the time that they enter the dead zone, the applicant theorizes that the particle will retain that momentum as it exists the dead zone, due to the absence of friction forces within the dead zone.

Usefully, the applicant observes that because each cyclotron in the stack of a plurality of cyclotrons includes an aperture, and because the apertures of the plurality of cyclotrons are axially aligned with one another, the dead space that is created within the aperture of each cyclotron align with the dead space created in the center of the other cyclotrons of the stack to form an elongated dead zone channel or conduit through which particles may travel a given linear distance. The applicant thereby theorizes that a stack of cyclotrons, so arranged, may be configured to produce a linear accelerator, whereby it is the creation of the dead zone within the central aperture of each cyclotron in the stack of cyclotrons which forms a linear acceleration channel through the center of the stack of axially aligned cyclotrons.

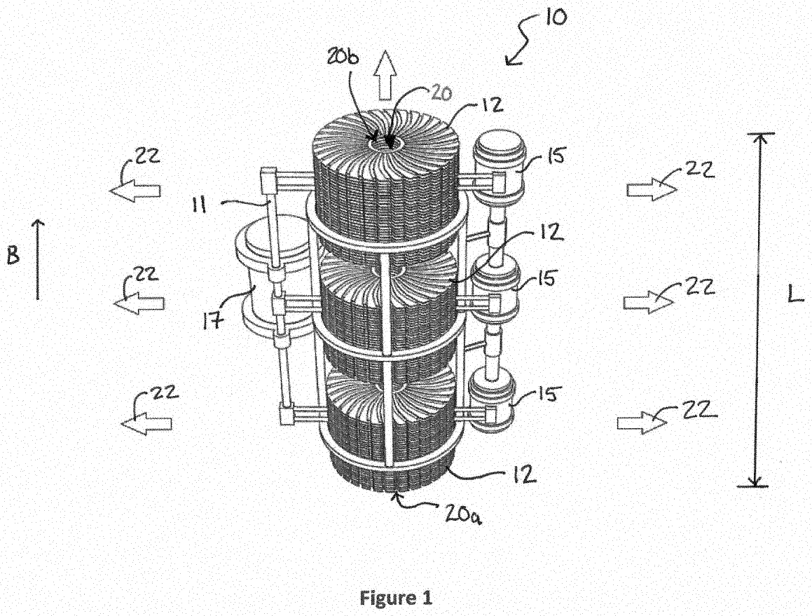

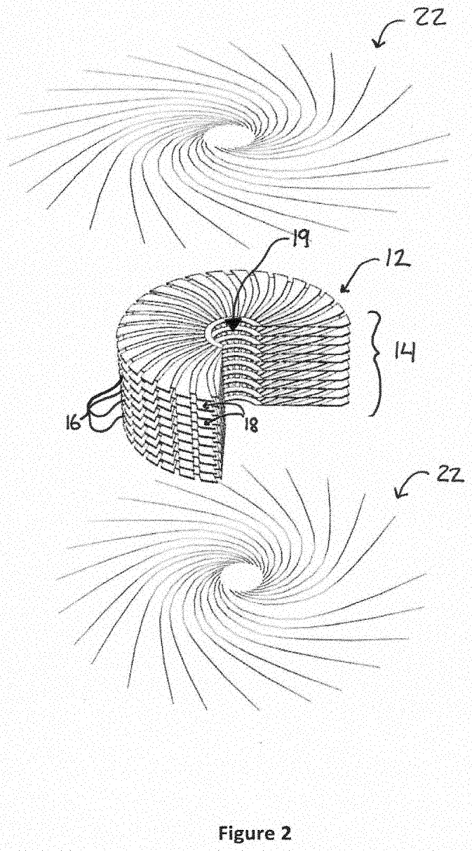

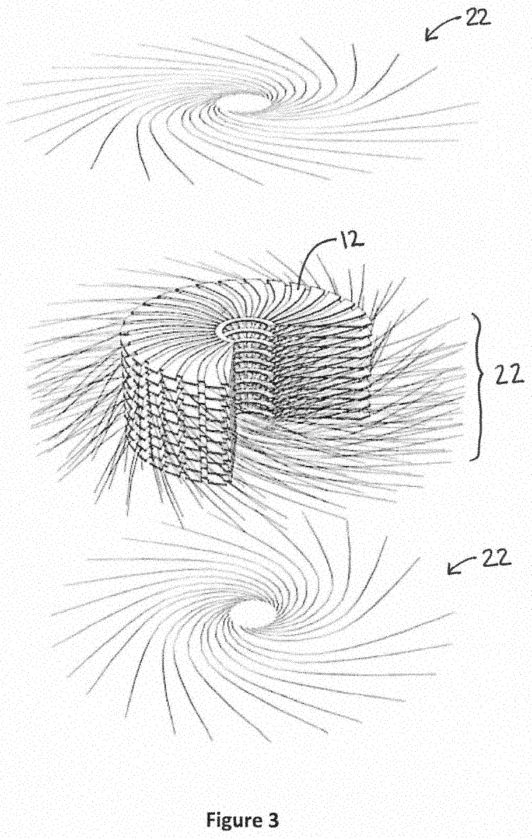

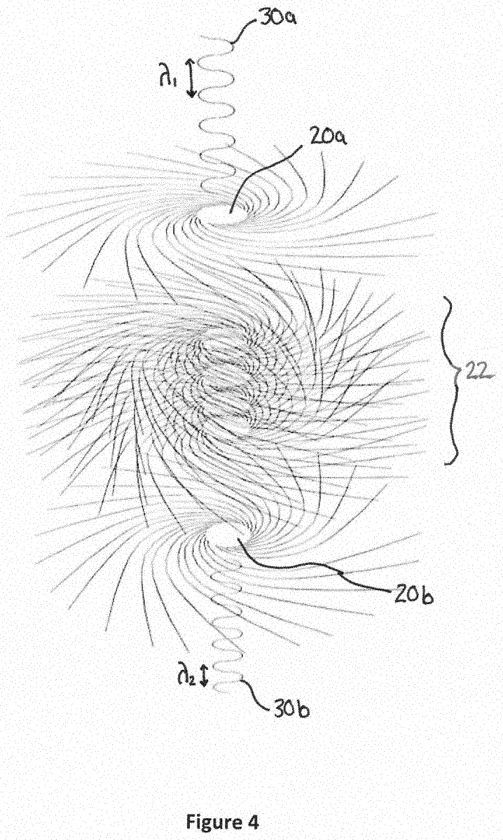

As an illustrative example, not intended to be limiting, applicant will describe an example of the novel linear accelerator constructed of a stacked plurality cyclotrons, with reference to FIGS. 1 to 4. As shown in FIG. 1, a linear accelerator 10 comprises a plurality of cyclotron stacks 12. As best seen in FIG. 2, each cyclotron stack 12 comprises a cylindrical acceleration vacuum chamber 14 having a plurality of spiral dees 16, the spiral dees 16 spaced apart so as to create a plurality of electron vents 18. Magnets, which may be electromagnets, are interleaved between each set of spiral dees 16 (not shown). A central aperture 19 passes through the center of each set of spiral dees 16, thereby creating a void or channel passing through the cyclotron stack 12.

Returning to FIG. 1, each of the cyclotron stacks 12 are arranged in axial alignment relative to the other cyclotron stacks 12 so as to form a stacked array of cyclotron stacks 12, whereby the central aperture 19 of each set of spiral dees 16 is axially aligned with one another in the stack 12. Although FIG. 1 illustrates three cyclotron stacks 12, each stack containing a plurality of cyclotrons 16, it will be appreciated that fewer or greater than three cyclotron stacks 12 may be used in forming the stacked array of the linear accelerator. Each cyclotron stack 12 may be provided with a capacitor 15 for supplying the oscillating electromagnetic field between the electrodes (spiral dees 16) of the cyclotron stack 12. As mentioned above, each cyclotron stack 12 includes the spiral dee 16 of each cyclotron in the stack 12 interleaved by magnets, such as electromagnets, which interleaved electromagnets create a magnetic field in direction B. Furthermore, the capacitors and the electromagnets (for embodiments utilizing capacitors and/or electromagnets) may be powered by a power supply 17. The various components in the linear accelerator 10 may be supported by a frame 11. As will be appreciated by a person skilled in the art, the capacitor 15 may be configured to produce the oscillating electromagnetic field for accelerating the particles through the gaps between the spiral dees in each set of spiral dees 16; however, the present invention is not limited to the use of capacitors for generating the oscillating electromagnetic field, and other means known in the art for producing an oscillating electromagnetic field may be employed, including but not limited to the use of a plurality of relays, gases, semiconductors, crystals or controlled pulse devices.

In some embodiments, a linear accelerator 10, comprised of an array of axially aligned cyclotron stacks 12, operates on the principle of creating a void or dead zone within the central channel 20 of the stack of cyclotrons 12. Although cyclotrons themselves are traditionally used as a particle accelerator, in this case, the cyclotrons are being used to evacuate the central channel 20 of the stack of cyclotrons 12 so as to create a space (otherwise referred to herein as the “dead zone”) that is devoid of any particles, and therefore also devoid of any field such as the electromagnetic field or the Higgs field, and it is this elongated, channel-shaped space which becomes the acceleration portion of the linear accelerator designed in accordance with the present disclosure. As such, although traditional cyclotrons utilize internal vertical deflectors so as to direct a beam of particles that have been accelerated at a given target, the cyclotrons 12 described herein are designed so as to leave open the sides of the cyclotron 12 such that electron vents 18 exist in the gaps between the plurality of spiral dees 16 within each cyclotron 12. The effect is that accelerated subatomic particles 22, which may include for example electrons, protons or neutrons, radiate outwardly of the stack of cyclotrons 12 in all directions surrounding the stack of cyclotrons 12, as shown for example in FIG. 1. In other embodiments, attempts may be made to direct the radiation 22 in a particular direction, and the design of the linear accelerator 10 is not intended to be limited to the design shown in FIG. 1, which is provided for illustrative purposes only.

As shown in FIG. 1, the central channel 20 of the array 10 of cyclotron stacks 12 includes an inlet 20a and an outlet 20b. In some embodiments, the applicant theorizes that a particle, which may include for example a particle beam, may enter the inlet 20a of the central channel 20 and thereby pass through the dead zone that is created within the central channel 20 of linear accelerator 10. Because the applicant theorizes there are no particles, virtual particles, or a Higgs field within the dead zone, there is nothing within the dead zone that could slow down or otherwise impose a frictional force upon the mass that is passing through the dead zone. Therefore, as the particle or mass passes through the dead zone, the particle or mass accelerates. When the accelerated mass exits the outlet 20b of the central conduit 20, it again encounters the electromagnetic field surrounding linear accelerator 10, as well as, potentially, particles such as gases in a surrounding atmosphere, and therefore the mass or particle once again slows down as it is once again subjected to frictional forces. However, because the mass or particle was accelerated during its passage through the dead zone, the mass or particle will exit the outlet 20b of the linear accelerator 10 at a higher velocity than the velocity at which the mass or particle entered the inlet 20a.

In some embodiments, rather than passing particles or particle beams through the dead zone, it may be possible accelerate larger bodies, such as projectiles or even vehicles, by passing the projectiles or vehicle through the linear accelerator 10. As before with a particle beam, such projectiles or vehicles, referred to herein generally as a “mass,” have momentum before the mass enters the inlet 20a of the central passage 20, and the mass maintains that momentum when it exits the outlet 20b. As the mass passes through the dead zone of central channel 20, there is no friction to slow it down because the dead zone is void of any particles or fields. The mass may travel faster than the speed of light as it travels through the dead zone, and theoretically, the mass might even become light when it is in the dead zone. In this manner, the linear accelerator 10 may thereby be capable of accelerating vehicles or projectiles through a very short distance, because the distance of the void may, for example, be the total length L of the central channel 20.

In some embodiments of the present disclosure, a light wave 30a may enter the dead zone through inlet 20a, rather than a mass. In such embodiments, the light wave 30a may enter at a given wavelength Δ₁ and when the light wave exits 30b through the outlet 20b of the central channel 20, the light wave 30b upon exit may have a wavelength λ₂, wherein the magnitude of the wavelength λ₂ is less than the wavelength λ₁, as a result of the light wave 30b gaining energy as compared to light wave 30a. The applicant theorizes that the light wave may come to a stop within the dead zone, and may have an increased energy density as it passes through the dead zone. Therefore, upon exit, the light wave would be shorter due to energy gained from passage through the dead zone, owing to the lack of friction existing in the dead zone. Thus, one practical application of the linear accelerator may include amplifying a laser beam, whereby the input laser 30a is of a given energy and wavelength, and then upon exit through the outlet 20b of the linear accelerator 10, the wavelength of the laser 30b may be shorter.

What is claimed is:

1. A linear accelerator, comprising:
a plurality of cyclotrons arranged axially in a cyclotron stack, each cyclotron of the plurality of cyclotrons comprising a set of dees and a central aperture passing through the set of dees, wherein each central aperture of each said cyclotron is axially aligned with one another so as to form a central channel passing through the cyclotron stack, the central channel having an inlet and an outlet, and wherein a first magnet is positioned adjacent the inlet and a second magnet is positioned adjacent the outlet;
a power supply configured to apply an oscillating voltage to each set of dees of the cyclotron stack;
wherein when in operation, subatomic particles are ejected radially outwardly of the plurality of cyclotrons thereby creating a dead zone within the central channel, wherein the dead zone is void of particles, subatomic particles and electromagnetic fields; and
wherein a mass entering the inlet of the central channel of the cyclotron stack is accelerated as it passes through the dead zone of the central channel and the outlet as a result of the absence of frictional forces acting on the mass within the dead zone of the central channel.

2. The linear accelerator of claim 1, wherein the first and second magnets are electromagnets and wherein the power supply is additionally configured to power the electromagnets.

3. The linear accelerator of claim 1 further comprising a plurality of interleaved magnets, the plurality of interleaved magnets positioned so as to interleave each magnet of the plurality of interleaved magnets between each set of dees of the plurality of cyclotrons.

4. The linear accelerator of claim 3, wherein the first and second magnets and the plurality of interleaved magnets are electromagnets and wherein the power supply is additionally configured to power the electromagnets.

5. The linear accelerator of claim 1, wherein the power supply is a controlled pulsed power supply configured to apply a pulsed power voltage to each set of dees of the plurality of cyclotrons.

6. The linear accelerator of claim 1, wherein the mass comprises a projectile.

7. The linear accelerator of claim 1, wherein the mass comprises a vehicle for space travel.

8. The linear accelerator of claim 1, wherein the mass comprises an atmosphere surrounding the vehicle and wherein the linear accelerator is configured as a propulsion system for propelling the vehicle through the said atmosphere.

9. The linear accelerator of claim 1, wherein the subatomic particles comprise electrons and virtual particles.

10. A linear accelerator, comprising:
a plurality of cyclotrons arranged axially in a cyclotron stack, each cyclotron of the plurality of cyclotrons comprising a set of dees and a central aperture passing through the set of dees, wherein each central aperture of each said cyclotron is axially aligned with one another so as to form a central channel passing through the cyclotron stack, the central channel having an inlet and an outlet, and wherein a first magnet is positioned adjacent the inlet and a second magnet is positioned adjacent the outlet;
a power supply configured to apply an oscillating voltage to each set of dees of the cyclotron stack;
wherein when in operation, subatomic particles are ejected radially outwardly of the plurality of cyclotrons thereby creating a dead zone within the central channel, wherein the dead zone is void of particles, subatomic particles and electromagnetic fields; and
wherein a beam of light entering the inlet of the cyclotron stack gains energy as it passes through the central channel and the outlet of the cyclotron stack.

11. The linear accelerator of claim 10, wherein the first and second magnets are electromagnets and wherein the power supply is additionally configured to power the electromagnets.

12. The linear accelerator of claim 10 further comprising a plurality of interleaved magnets, the plurality of interleaved magnets positioned so as to interleave each magnet of the plurality of interleaved magnets between each set of dees of the plurality of cyclotrons.

13. The linear accelerator of claim 12, wherein the first and second magnets and the plurality of interleaved magnets are electromagnets and wherein the power supply is additionally configured to power the electromagnets.

14. The linear accelerator of claim 10, wherein the power supply is a controlled pulsed power supply configured to apply a pulsed power voltage to each set of dees of the plurality of cyclotrons.

15. The linear accelerator of claim 10, wherein the beam of light is configured as a laser.
